(19) United States
(12) Patent Application Publication
(10) Pub. No.: US 2013/0125658 A1
(43) Pub. Date: May 23, 2013

(54) SEMICONDUCTOR TEST APPARATUS

(71) Applicants: Sang-Jun Lee, Cheonan-si (KR); Young-Gil Lee, Asan-si (KR)

(72) Inventors: Sang-Jun Lee, Cheonan-si (KR); Young-Gil Lee, Asan-si (KR)

(21) Appl. No.: 13/489,719

(22) Filed: Jun. 6, 2012

(30) Foreign Application Priority Data
Nov. 17, 2011 (KR) 10-2011-0120378

(51) Int. Cl. B06B 3/00

(52) U.S. Cl. 73/663

(57) ABSTRACT

A semiconductor test apparatus is provided. The semiconductor test apparatus includes a plate on which a custom tray is mounted, a carrier connected to the plate to transfer the plate, and a vibrator vibrating the plate while the plate is transferred.

### CROSS-REFERENCE TO RELATED APPLICATION

This application claims priority under 35 U.S.C. §119 to Korean Patent Application No. 10-2011-0120378, filed on Nov. 17, 2011, in the Korean Intellectual Property Office (KIPO), the entire contents of which are incorporated herein by reference.

### BACKGROUND

1. Field of the Invention

The present inventive concepts relate to a semiconductor test apparatus.

2. Description of the Related Art

A test handler is an apparatus used to test failures of manufactured semiconductor devices and to classify the semiconductor devices according to test results before shipment to markets.

A semiconductor device to be tested is placed in a custom tray and then is loaded into the test handler. Then, the semiconductor device to be tested is transferred from the custom tray to a test tray. The semiconductor device transferred to the test tray passes through at least one test procedure. The tested semiconductor device is transferred from the test tray to the custom tray and unloaded.

As described above, the semiconductor device may be transferred from the custom tray to the test tray and/or vice versa. During the procedure, a semiconductor device to be tested may not be mounted in an accurate pocket of the custom tray and/or the test tray due to various conditions. Accordingly, mounting failures may be generated.

Such mounting failures may generate errors in subsequent operations of the test handler or may cause a quality problem to the semiconductor device to be tested. Further, to identify the mounting failures, it is necessary to make the test handler stop operation, thereby lowering a throughput.

### SUMMARY

The present inventive concepts provide a semiconductor test apparatus, which can solve a mounting failure problem, thereby improving quality of a semiconductor device and increasing a throughput.

The present inventive concept will be described in or be apparent from the following description of example embodiments.

According to example embodiments, a semiconductor test apparatus may include a plate on which a custom tray is mounted, a carrier connected to the plate to transfer the plate, and a vibrator vibrating the plate while the plate is transferred.

The vibrator may vibrate the plate while transferring the plate.

The vibrator may vibrate the plate first and then transfer the same, or transfer the plate first and then vibrate the same.

The plate may have a first surface and a second surface, and the custom tray may be mounted on the first surface of the plate and the vibrator may be mounted on the second surface of the plate.

The vibrator may include first and second vibration elements disposed at opposite sides of the second surfaces of the plate and a third vibration element disposed at the center of the second surface of the plate.

The semiconductor test apparatus may further include a controller controlling a vibrating operation of the vibrator.

The controller may control at least one of vibration time, a number of vibrations and vibration power of the vibrator.

A user may set at least one of the vibration time, the number of vibration and the vibration power of the vibrator.

The semiconductor test apparatus may include a plurality of plates and a plurality of vibrators vibrating the respective plates, and the controller may individually operate the plurality of vibrators.

If more than a preset number of semiconductor devices are accommodated in the custom tray, the carrier may transfer the plate downwardly and transmits a transfer signal indicative of downward transfer to the controller, and the controller may operate the vibrator in response to the transfer signal.

The carrier may include a frame elongated in a first direction, a cylinder installed in the frame, and a piston installed in the cylinder and capable of reciprocating in the first direction and the plate may be connected to the piston and reciprocate in the first direction.

According to example embodiments, a semiconductor test apparatus may include at least one of a loader and an unloader including a plate on which a custom tray is mounted and which is transferred from a first position to a second position if more than a preset number of semiconductor devices are accommodated in the custom tray, and a vibrator vibrating the plate while the plate is transferred, and a transferer transferring the plate when the plate reaches the second position.

The transferer may transfer the plate at least one of to one of a plurality of unloading stackers and from a plurality of loading stackers.

The at least one of a loader and an unloader may further include a controller controlling a vibrating operation of the vibrator.

The controller may control at least one of vibration time, a number of vibration and vibration power of the vibrator.

A user may set at least one of the vibration time, the number of vibration and the vibration power of the vibrator.

According to example embodiments, a semiconductor apparatus may include a plate configured to mount a custom tray thereon, the plate configured to be vibrated in a first direction while the plate is transferred such that the custom tray is stably mounted on the plate, and a transferor configured to transfer the plate.

The plate may include a vibrator and the vibrator may be configured to vibrate the plate while the plate is transferred.

The plate may be configured to be vibrated in an up-and-down direction.

The transferor may be configured to be vibrated in a second direction different from the first direction.

### BRIEF DESCRIPTION OF THE DRAWINGS

The above and other features and advantages of the present inventive concepts will become more apparent by describing in detail example embodiments thereof with reference to the attached drawings in which:

FIG. 1 is a block diagram of a semiconductor test apparatus according to example embodiments;

FIGS. 2 to 4 are conceptual diagrams illustrating the operation of an unloading unit shown in FIG. 1;

FIG. 5 is a perspective view of an unloader shown in FIGS. 1 and 2;

FIG. 6 is a partial perspective view of the unloader shown in FIG. 5 and having a custom tray thereon;

FIG. 7 is a plan view illustrating the other surface of a plate;

FIG. 8 is a conceptual diagram illustrating the operation of the unloader shown in FIGS. 1 and 2; and

FIG. 9 is a timing diagram illustrating the operation of the unloader shown in FIGS. 1 and 2.

It should be noted that these figures are intended to illustrate the general characteristics of methods, structure and/or materials utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments. For example, the relative thicknesses and positioning of molecules, layers, regions and/or structural elements may be reduced or exaggerated for clarity. The use of similar or identical reference numbers in the various drawings is intended to indicate the presence of a similar or identical element or feature.

### DETAILED DESCRIPTION OF THE EMBODIMENTS

Example embodiments will now be described more fully hereinafter with reference to the accompanying drawings. Example embodiments may, however, be embodied in different forms and should not be construed as limited to the embodiments set forth herein; rather, these embodiments are provided so that this disclosure will be thorough and complete, and will fully convey the concept of example embodiments to those of ordinary skill in the art. Like reference numerals in the drawings denote like elements, and thus their description will be omitted.

It will be understood that when an element or layer is referred to as being “connected to,” or “coupled to” another element or layer, it can be directly connected to or coupled to another element or layer or intervening elements or layers may be present. In contrast, when an element is referred to as being “directly connected to” or “directly coupled to” another element or layer, there are no intervening elements or layers present. As used herein, the term “and/or” includes any and all combinations of one or more of the associated listed items. Other words used to describe the relationship between elements or layers should be interpreted in a like fashion (e.g., “between” versus “directly between,” “adjacent” versus “directly adjacent,” “on” versus “directly on”).

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, for example, a first element, a first component or a first section discussed below could be termed a second element, a second component or a second section without departing from the teachings of example embodiments.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of example embodiments. The use of the terms “a” and “an” and “the” and similar referents in the context of describing the invention (especially in the context of the following claims) are to be construed to cover both the singular and the plural, unless otherwise indicated herein or clearly contradicted by context. It will be further understood that the terms “comprises”, “comprising”, “includes” and/or “including,” if used herein, specify the presence of stated features, integers, steps, operations, elements and/or components, but do not preclude the presence or addition of one or more other features, integers, steps, operations, elements, components and/or groups thereof.

Example embodiments are described herein with reference to cross-sectional illustrations that are schematic illustrations of idealized embodiments (and intermediate structures) of example embodiments. As such, variations from the shapes of the illustrations as a result, for example, of manufacturing techniques and/or tolerances, are to be expected. Thus, example embodiments should not be construed as limited to the particular shapes of regions illustrated herein but are to include deviations in shapes that result, for example, from manufacturing. For example, an implanted region illustrated as a rectangle may have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of example embodiments. It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

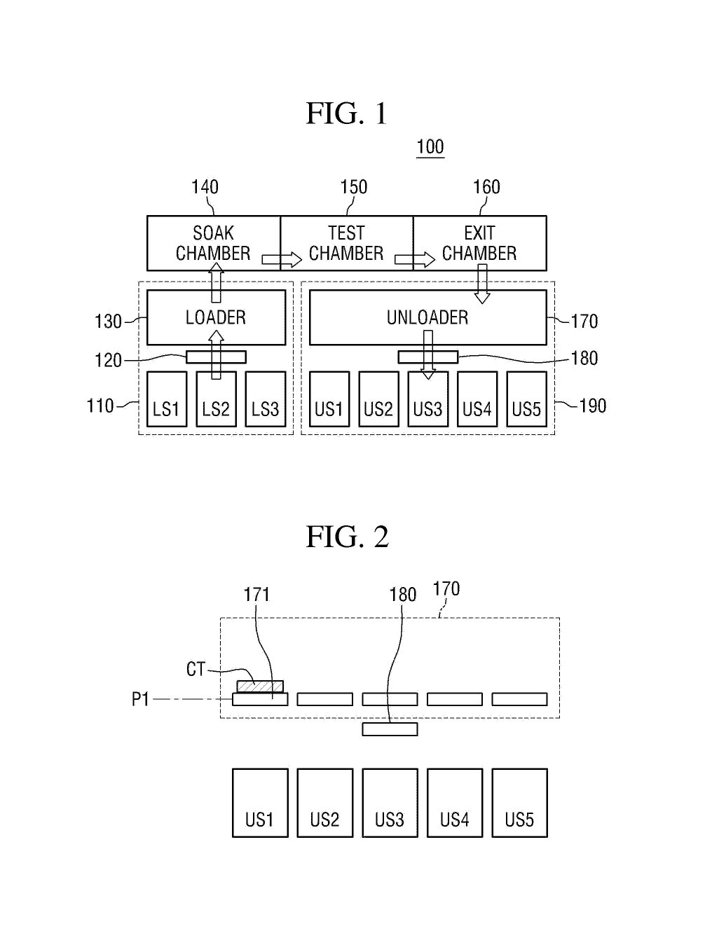

Unless defined otherwise, all technical and scientific terms used herein have the same meaning as commonly understood by one of ordinary skill in the art to which example embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein. FIG. 1 is a block diagram of a semiconductor test apparatus according to example embodiments of the present inventive concepts.

Referring to FIG. 1, the semiconductor test apparatus 100 according to example embodiments may include a loading unit 110, a soak chamber 140, a test chamber 150, exit chamber 160, and an unloading unit 190.

Arrows indicate movement paths of a semiconductor device to be tested.

The loading unit 110 may include, for example, a plurality of loading stackers LS1 to LS3, a first transferer 120, and a loader 130.

A plurality of custom trays CT each accommodating semiconductor devices to be tested may be mounted on the loading stackers LS1 to LS3. The plurality of custom trays CT may be mounted perpendicular to the loading stackers LS1 to LS3. In the illustrated example embodiments, there are three of the loading stackers LS1 to LS3, but example embodiments of the inventive concepts are not limited thereto. The first transferer 120 may transfer the custom trays mounted on the loading stackers LS1 to LS3 to the loader 130. The semiconductor device accommodated in each custom tray CT may be transferred to a test tray within the loader 130. Then, the test tray may be transferred to the soak chamber 140.

The soak chamber 140 may be disposed to be adjacent to the loading unit 110 and may heat or cool the semiconductor device transferred from the loading unit 110 to a desired (or alternatively predetermined) temperature.

The test chamber 150 may connect a test means to the semiconductor device to perform testing. As shown, the test chamber 150 may be disposed between the soak chamber 140 and the exit chamber 160, but example embodiments of the inventive concepts are not limited thereto.

The exit chamber 160 may be disposed to be adjacent to the unloading unit 190 and may cool or heat the tested semiconductor device to be in an original room temperature state.

The unloading unit 190 may include an unloader 170, a second transferer 180, and a plurality of unloading stackers US1 to US5.

In the unloader 170, the semiconductor device accommodated in the test tray and tested may be transferred to the custom tray. The second transferer 180 may mount the custom tray accommodating the semiconductor device on one of the plurality of unloading stackers US1 to US5. The custom trays may be vertically mounted on the unloading stackers US1 to US5. In the illustrated example embodiments, there are five of the unloading stackers US 1 to USS, but example embodiments are not limited thereto.

Hereinafter, the operation of the unloading unit 190 will be described in detail with reference to FIGS. 2 to 4. FIGS. 2 to 4 are conceptual diagrams illustrating the operation of an unloading unit 190 shown in FIG. 1.

Referring to FIG. 2, a plurality of plates 171 may be disposed within in the unloader 170. The plurality of plates 171 may be positioned at a first position P1. In addition, a custom tray CT may be mounted on at least one of the plates 171.

As described above, the tested semiconductor devices may be transferred from the test tray to the custom tray CT. Here, some of the tested semiconductor devices transferred from the test tray may not be accurately mounted in a pocket of the custom tray.

Meanwhile, the plates 171 may perform movement in a first direction (for example, up-and-down movement). The second transferer 180 may perform movement in a second direction different from the first direction (for example, left-and-right movement). The movement directions of the plates 171 and the second transferer 180 are provided only for illustration, but example embodiments are not limited thereto.

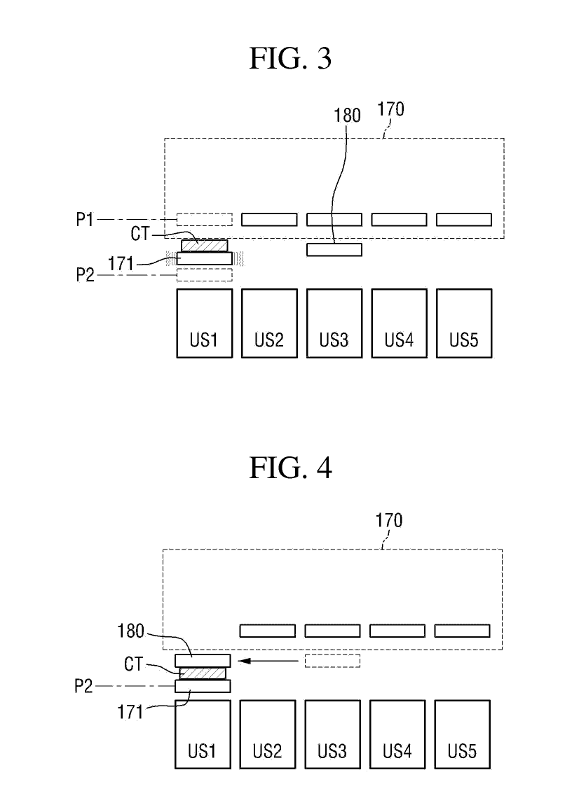

Referring to FIG. 3, if more than a desirable (or alternatively preset) number of semiconductor devices are accommodated in the custom tray CT (for example, if the custom tray CT is fully filled), the plate 171 may start moving from the first position P1 to a second position P2.

In FIG. 3, the first position P1 may be above the second position P2, but example embodiments are not limited thereto. According to example embodiments, the first position P1 and the second position P2 may be changed. For example, the first position P1 and the second position P2 may be on the same plane, or the first position P1 may be below the second position P2.

According to example embodiments, the plate 171 may be vibrated while the plates 171 are transferred. For example, the plates 171 may be vibrated while being transferred, the plates 171 may be vibrated and then be transferred, or the plates 171 may be transferred first and then be vibrated.

FIG. 3 illustrates the case where the plates 171 are vibrated while being transferred by way of example.

If the plates 171 are vibrated as stated above, a semiconductor device that has not been accurately mounted on a pocket of the custom tray CT can be stably mounted on the pocket. Accordingly, a mounting failure of the semiconductor device can be solved.

Referring to FIG. 4, the second transferer 180 may move onto the custom tray CT. The second transferer 180 may adsorb the custom tray CT and transfer the same to one of the plurality of unloading stackers US1 to US5.

As described above, because and the semiconductor device is stably mounted on the plate 171 due to the vibration of the plate 171, a defect (for example, a pressed-ball defect) may not occur to the semiconductor device even if the second transferer 180 adsorbs and transfers the custom tray CT.

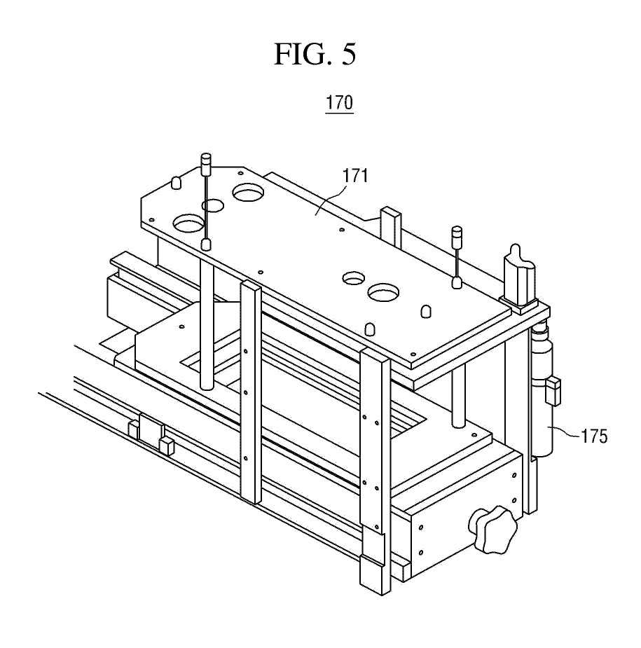

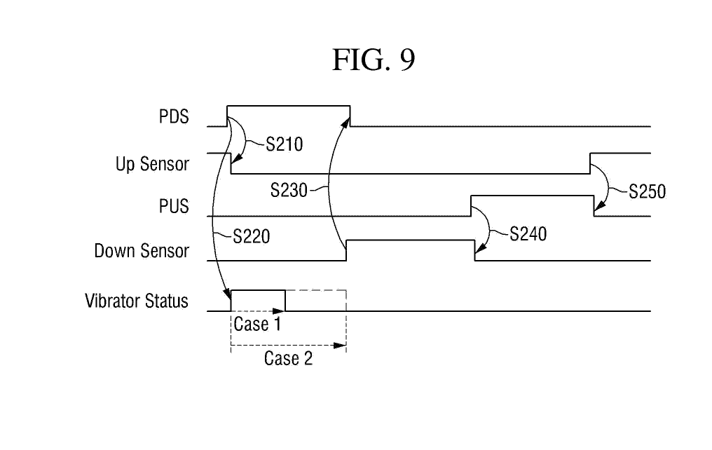

Hereinafter, the unloader 170 capable of vibrating the plates 171 will be described with reference to FIGS. 5 to 9.

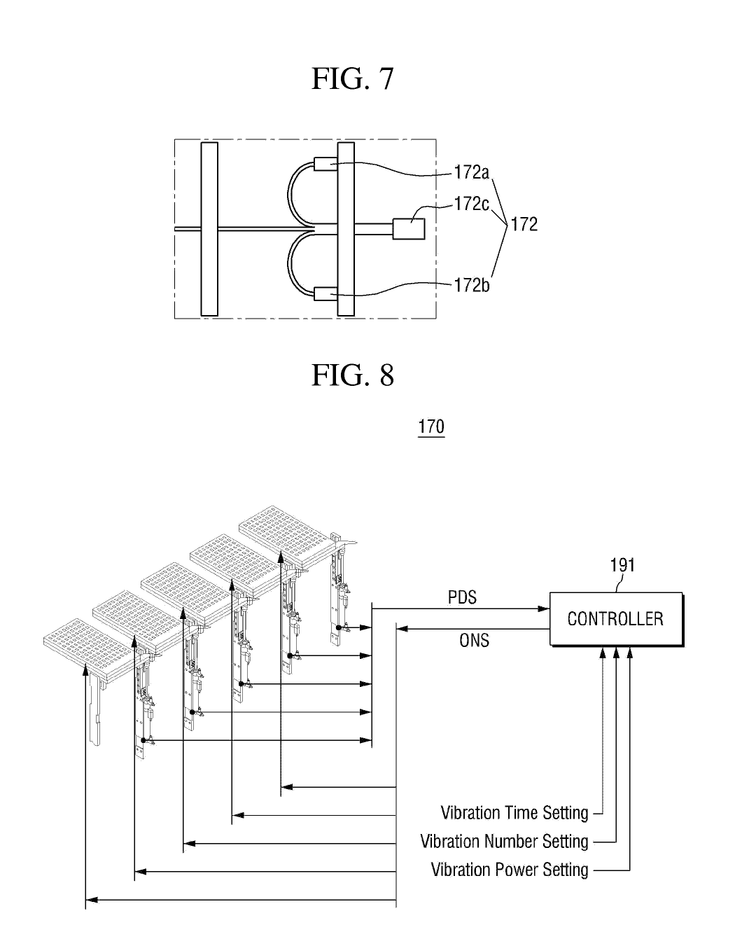

FIG. 5 is a perspective view of the unloader 170 shown in FIGS. 1 and 2, FIG. 6 is a partial perspective view of the unloader shown in FIG. 5 and having a custom tray thereon, FIG. 7 is a plan view illustrating the other surface of a plate, FIG. 8 is a conceptual diagram illustrating the operation of the unloader shown in FIGS. 1 and 2, and FIG. 9 is a timing diagram illustrating the operation of the unloader shown in FIGS. 1 and 2.

Referring first to FIGS. 5 to 7, the unloader 170 may include plates 171 on each of which a custom tray CT is mounted, a carrier 175 connected to the plate 171 and transfers the same, and a vibrator 172 vibrating the plate 171 while the plate 171 is transferred.

The plate 171 has one surface (e.g., a top surface) and the other surface (e.g., a rear surface). The custom tray CT may be mounted on the one surface of the plate 171 and the vibrator 172 may be mounted on the other surface of the plate 171.

The vibrator 172, for example, a plurality of vibration elements 172a to 172c, may be mounted on the other surface of the plate 171. As illustrated in FIG. 7, three vibration elements 172a to 172c, for example, may be mounted on the other surface of the plate 171. The first and second vibration elements 172a and 172b may be disposed at opposite sides of the other surface of the plate 171, and the third vibration element 172c may be disposed at the center of the other surface of the plate 171. Various types of the vibration elements 172a to 172c may be used, including a motor type, an air type, and so on.

The carrier 175 may include a frame 174, a cylinder 178 and a piston 179.

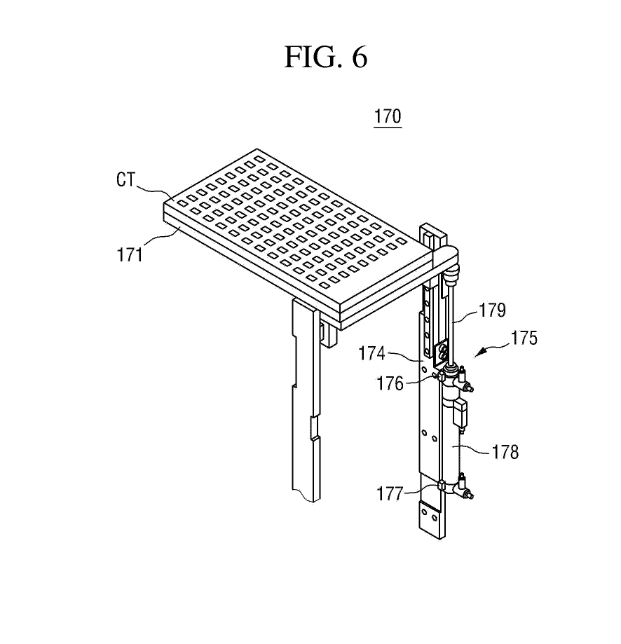

The frame 174 may be elongated in a third direction (for example, up-and-down movement in FIG. 6). The cylinder 178 may be installed in the frame 174, and the piston 179 may be installed in the cylinder 178 and reciprocate in the third direction. The cylinder 178 may be controlled by a hydraulic pressure, but example embodiments are not limited thereto. As shown in FIG. 6, the plate 171 may be connected to the piston 179 and be capable of reciprocate in the third direction as the piston 179 reciprocates.

Meanwhile, an up sensor 176 and a down sensor 177 may be installed in the frame 174. The up sensor 176 may sense upward movement of the piston 179 or the plate 171, and the down sensor 177 may sense downward movement of the piston 179 or the plate 171. For example, when the piston 179 or the plate 171 upwardly moves, a signal of the up sensor 176 may be activated to a high level, and when the piston 179 or the plate 171 downwardly moves, a signal of the down sensor 177 may be activated to a high level.

Referring to FIG. 8, the unloader 170 may further include a controller 191 controlling a vibrating operation.

The controller 191 may control at least one of vibration time, the number of vibration and/or vibration power of the vibrator. In addition, the at least one of vibration time, vibration number and/or vibration power of the vibrator may be set by a user. For example, the user may set such that the vibrator 172 minutely vibrates 250 times per second. The controller 191 may control the vibrator 172 as set by the user.

As described above, if more than a desirable (or alternatively preset) number of semiconductor devices are accommodated in the custom tray CT, the carrier 175 may transfer the plate 171 downwardly. Here, carrier 175 may transmit a transfer signal PDS indicative of downward transfer to the controller 191. The controller 191 may turn on the vibrator 172 in response to the transfer signal PDS. For example, the controller 191 may supply the vibrator 172 with a turn-on signal ONS to turn on the vibrator 172.

As shown in FIG. 8, the unloader 170 may include a plurality of plates 171 and a plurality of vibrators 172 vibrating the respective plates 171. According to example embodiments, the controller 191 may individually operate some of the plurality of vibrators 172. For example, the controller 191 may vibrate only the first one of five plates 171, which has been supplied with the transfer signal PDS.

Referring to FIGS. 6, 8 and 9, if more than a desirable (or alternatively preset) number of semiconductor devices are accommodated in the custom tray CT, the carrier 175 may transfer the plate 171 downwardly. Here, the transfer signal PDS output from the carrier 175 may be at a high level.

The signal of the up sensor 176 may be deactivated to a low level according to the change of the transfer signal PDS (S210).

The vibrator 172 may receive the transfer signal PDS to start vibrating (S220). As described above, the vibration time may be adjusted as set by the user. For example, the vibration may last for a short time (Case 1) or may last for a relatively long time (Case 2).

The down sensor 177 may sense that the plate 171 moves downward. Therefore, the signal of the down sensor 177 may be activated to a high level. The transfer signal PDS may be deactivated to a low level according to the change of the signal of the down sensor 177 (S230). If transfer signal PDS is deactivated to a low level, the plate 171 may not move downward any further.

The controller 191 may enable a return signal PUS. If the return signal PUS is activated to a high level, the plate 171 may start to move upward again. The movement of the plate 171 may be sensed by the signal of the down sensor 177, and the signal of the down sensor 177 may be deactivated to a low level (S240).

The up sensor 176 may sense that the plate 171 moves upward. Therefore, the signal of the up sensor 176 may be activated to a high level. The return signal PUS may be deactivated to a low level according to the change of the signal of the up sensor 176 (S250). FIGS. 2 to 9 illustrate that the vibrator 172 may be installed on the plate 171 disposed in the unloader 170, but example embodiments are not limited thereto. For example, example embodiments may be applied to any plate as long as it transfers a tray in which semiconductor devices are accommodated. Accordingly, example embodiments may be applied to a plate in the loader 130 of the semiconductor test apparatus shown in FIG. 1.

While example embodiments have been particularly shown and described, it will be understood by one of ordinary skill in the art that various changes in form and details may be made therein without departing from the spirit and scope of the present invention as defined by the following claims.

What is claimed is:

1. A semiconductor test apparatus comprising:
a plate on which a custom tray is mounted;
a carrier connected to the plate to transfer the plate; and
a vibrator vibrating the plate while the plate is transferred.

2. The semiconductor test apparatus of claim 1, wherein the vibrator vibrates the plate while transferring the plate.

3. The semiconductor test apparatus of claim 1, wherein the vibrator vibrates the plate first and then transfers the same, or transfers the plate first and then vibrates the same.

4. The semiconductor test apparatus of claim 1, wherein the plate has a first surface and a second surface, and the custom tray is mounted on the first surface of the plate and the vibrator is mounted on the second surface of the plate.

5. The semiconductor test apparatus of claim 4, wherein the vibrator comprises first and second vibration elements disposed at opposite sides of the second surfaces of the plate and a third vibration element disposed at the center of the second surface of the plate.

6. The semiconductor test apparatus of claim 1, further comprising a controller controlling a vibrating operation of the vibrator.

7. The semiconductor test apparatus of claim 6, wherein the controller controls at least one of vibration time, a number of vibration and vibration power of the vibrator.

8. The semiconductor test apparatus of claim 7, wherein a user sets at least one of the vibration time, the number of vibration and the vibration power of the vibrator.

9. The semiconductor test apparatus of claim 6, wherein the semiconductor test apparatus comprises a plurality of plates and a plurality of vibrators vibrating the respective plates, and the controller individually operates the plurality of vibrators.

10. The semiconductor test apparatus of claim 6, wherein if more than a preset number of semiconductor devices are accommodated in the custom tray, the carrier transfers the plate downwardly and transmits a transfer signal indicative of downward transfer to the controller, and the controller operates the vibrator in response to the transfer signal.

11. The semiconductor test apparatus of claim 1, wherein the carrier comprises a frame elongated in a first direction, a cylinder installed in the frame, and a piston installed in the cylinder and capable of reciprocating in the first direction and the plate is connected to the piston and reciprocates in the first direction.

12. A semiconductor test apparatus comprising:
at least one of a loader and an unloader including a plate on which a custom tray is mounted and which is transferred from a first position to a second position if more than a preset number of semiconductor devices are accommodated in the custom tray, and a vibrator vibrating the plate while the plate is transferred; and
a transferer transferring the plate the plate reaches the second position.

13. The semiconductor test apparatus of claim 12, wherein the transferer transfers the plate at least one of to one of a plurality of unloading stackers and from a plurality of loading stackers.

14. The semiconductor test apparatus of claim 12, wherein the at least one of a loader and an unloader further comprises a controller controlling a vibrating operation of the vibrator.

15. The semiconductor test apparatus of claim 14, wherein the controller controls at least one of vibration time, a number of vibration and vibration power of the vibrator.

16. The semiconductor test apparatus of claim 15, wherein a user sets at least one of the vibration time, the number of vibration and the vibration power of the vibrator.

17. A semiconductor test apparatus comprising:
a plate configured to mount a custom tray thereon, the plate configured to be vibrated in a first direction while the plate is transferred such that the custom tray is stably mounted on the plate; and
a transferor configured to transfer the plate.

18. The semiconductor test apparatus of claim 17, wherein the plate includes a vibrator, the vibrator configured to vibrate the plate while the plate is transferred.

19. The semiconductor test apparatus of claim 17, wherein the plate is configured to be vibrated in an up-and-down direction.

20. The semiconductor test apparatus of claim 17, wherein the transferor is configured to be vibrated in a second direction different from the first direction.
